(19) United States
(12) Patent Application Publication
(10) Pub. No.: US 2018/0354165 A1
(43) Pub. Date: Dec. 13, 2018

(54) Apparatus for Making a Continuous Molded Web

(71) Applicant: Jing-Shown Wu, Taipei City (TW)

(72) Inventor: Jing-Shown Wu, Taipei City (TW)

(21) Appl. No.: 16/001,622

(22) Filed: Jun. 6, 2018

(30) Foreign Application Priority Data
Jun. 9, 2017 (TW) 106119290

(51) Int. Cl. B29C 41/28; B29C 41/52; B29C 41/38; B29C 41/46; B29C 71/00

(52) U.S. Cl. CPC B29C 41/28; B29C 41/52; B29L 2007/008; B29C 41/46; B29C 71/0009; B29C 41/38

(57) ABSTRACT

An apparatus for making a continuous molded web includes a filling zone, a cooling zone, a plurality of rollers, a conveyer belt, a first feeding member, a pair of rails, a mounting frame, and a second feeding member. The conveyer belt includes a plurality of longitudinal and transverse grooves. The first feeding member delivers a pressurized molten resin into the longitudinal grooves, and the second feeding member delivers the pressurized molten resin into the transverse grooves, thereby forming a web of the pressurized molten resin which is moved forward into the cooling zone for making the continuous molded web.

### CROSS-REFERENCE TO RELATED APPLICATION

This application claims priority of Taiwanese Application No. 106119290, filed on Jun. 9, 2017.

### FIELD

The disclosure relates to an apparatus, and more particularly to an apparatus for making a continuous molded web.

### BACKGROUND

Various net-like products, such as fishing nets, mosquito nets, cages, fence nets, screen nets, shielding nets, and the like are used widely in daily life. The net-like products are usually made by weaving or knotting threads or by subjecting intercrossing strands interconnection together at interconnection points of the strands via hot-melt adhesion, hot pressing, or the like.

There remains a need in the art for a more efficient means for production of net-like products.

U.S. Pat. No. 3,515,778 discloses a process for continuous molding of a molten thermoplastic resin into a web. In the process, the molten thermoplastic resin (e.g., polyethylene) is forced into a pattern on a surface of a rotating roll to form a web of the resin with the pattern. In an apparatus disclosed in the prior art for performing the process, a clearance has to be formed between a roll and a doctor blade. Thus, when the web is removed from the roll, residual thermoplastic resin may unavoidably be left on the roller, especially on the embossing areas defined by transverse grooves and intersecting grooves of the roll, which requires troublesome task to remove the residual thermoplastic resin periodically.

### SUMMARY

An object of the disclosure is to provide an apparatus for making a continuous molded web efficiently.

According to the disclosure, there is provided an apparatus for making a continuous molded web. The apparatus comprises a filling zone, a cooling zone, a plurality of rollers, a conveyer belt, a first feeding member, a pair of rails, a mounting frame, and a second feeding member.

The filling zone extends in a longitudinal direction to terminate at a starting end region and a first juncture region.

The cooling zone extends in the longitudinal direction to terminate at a second juncture region connected to the first juncture region and a finishing end region.

The plurality of the rollers are displaced from each other in the longitudinal direction.

The conveyer belt is trained over the rollers to move along the longitudinal direction from the filling zone to the cooling zone, and includes a plurality of longitudinal grooves and a plurality of transverse grooves. The longitudinal grooves extend in a leading-and-trailing direction parallel to the longitudinal direction and displace from each other in a widthwise direction. The transverse grooves extend in the widthwise direction and displace from each other in the leading-and-trailing direction to intersect the longitudinal grooves to form an patterned mold.

The first feeding member is used for delivering a pressurized molten resin in the starting end region, and includes a plurality of first outlets which are displaced from each other in a transverse direction transverse to the longitudinal direction and which are disposed over and in register with the longitudinal grooves, respectively such that the pressurized molten resin is delivered through the first outlets into the longitudinal grooves, respectively when the conveyer belt is moved into the starting end region.

The pair of the rails extend in the longitudinal direction and are disposed outboard of the conveyer belt.

The mounting frame extends in the transverse direction to terminate at two guided end regions which are guided by the pair of the rails, respectively to permit the mounting frame to transform between a synchronizing state where the mounting frame is moved with the conveyor belt and a non-synchronizing state where the mounting frame is not moved with the conveyor belt.

The second feeding member is elongated along a lengthwise line, and includes a plurality of second outlets which are displaced from each other along the lengthwise line and which are mounted on the mounting frame with the lengthwise line oriented in the longitudinal direction to permit the second outlets to be in register with the transverse grooves, respectively such that the pressurized molten resin is delivered through the second outlets into the transverse grooves, respectively when the second feeding member is moved in the synchronizing state, thereby forming a web of the pressurized molten resin in the patterned mold to be moved forward into the cooling zone for making the continuous molded web.

### BRIEF DESCRIPTION OF THE DRAWINGS

Other features and advantages of the disclosure will become apparent in the following detailed description of the embodiment (s) with reference to the accompanying drawings, of which:

FIG. 1 is a schematic view illustrating a first embodiment of an apparatus for making a continuous molded web according to the disclosure;

FIG. 2 is a top view of the first embodiment to illustrate a starting state of feeding of a second feeding member included in the first embodiment;

FIG. 3 is another top view of the first embodiment to illustrate an ending state of feeding of the second feeding member included in the first embodiment;

FIG. 4 is a fragmentary sectional view of a conveyer belt included in the first embodiment;

FIG. 5 is a schematic view illustrating a second embodiment of an apparatus for making a continuous molded web according to the disclosure;

FIG. 6 is a fragmentary sectional view of the conveyer belt included in the second embodiment;

FIG. 7 is a schematic view illustrating a third embodiment of an apparatus for making a continuous molded web according to the disclosure; and

FIG. 8 is a fragmentary sectional view of the conveyer belt included in the third embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

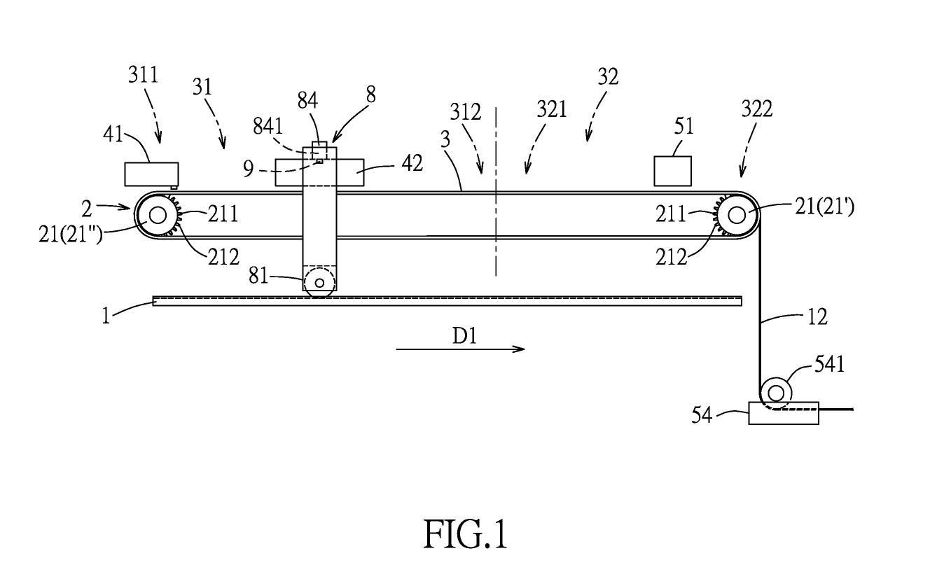

Referring to FIGS. 1, 2, 3, and 4, a first embodiment of an apparatus for making a continuous molded web according to the disclosure comprises a filling zone 31, a cooling zone 32, a plurality of rollers 21, a conveyer belt 3, a first feeding member 41, a pair of rails 1, a mounting frame 8, a second feeding member 42, a sensor 9, a controller (now shown), a cooling member 51, and a dyeing tank 54.

The filling zone 31 extends in a longitudinal direction (D1) to terminate at a starting end region 311 and a first juncture region 312.

The cooling zone 32 extends in the longitudinal direction (D1) to terminate at a second juncture region 321 and a finishing end region 322. The second juncture region 321 is connected to the first juncture region 311.

The plurality of the rollers 21 cooperate with each other to constitute an actuating unit 2, are displaced from each other in the longitudinal direction (D1). The plurality of the rollers 21 includes a leading roller 21′ and a trailing roller 21″ which are disposed at the finishing end region 322 and the starting end region 311, respectively. Each of the leading and trailing rollers 21′, 21″ includes two annular toothed end regions 211 opposite to each other in an axial direction. Each of the annular toothed end regions 211 has a plurality of teeth 212.

The conveyer belt 3 is trained over the rollers 21 to move along the longitudinal direction (D1) from the filling zone 31 to the cooling zone 32. Specifically, The conveyer belt 3 is trained around the leading roller 21′ and the trailing roller 21″ so as to render the conveyer belt 3 to be a looped one.

The conveyer belt 3 includes a plurality of longitudinal grooves 33 and a plurality of transverse grooves 34. The longitudinal grooves 33 extend in a leading-and-trailing direction (D2) parallel to the longitudinal direction (D1) and displace from each other in a widthwise direction (D3). The transverse grooves 34 extend in the widthwise direction (D3) and displace from each other in the leading-and-trailing direction (D2) to intersect the longitudinal grooves 33 to form a patterned mold 36. Each of the longitudinal and transverse grooves 33, 34 is configured to be of a shape of polygon, arc, and the like.

The conveyer 3 further includes two perforated marginal regions 35 at opposite sides of the patterned mold 36. Each of the perforated marginal regions 35 includes a plurality of perforations 351 which are displaced from each other in the leading-and-trailing direction D2 and which are configured such that when the conveyer belt 3 is trained around the leading and trailing rollers 21′, 21″, the perforations 351 are sequentially brought into mesh engagement with the teeth 212 of the leading and trailing rollers 21′, 21″, thereby ensuring positive friction engagement therebetween.

The first feeding member 41 is used for delivering a pressurized molten resin 11 (for example, a pressured molten thermoplastic polymeric material such as polyethylene, acrylic, and the like) in the starting end region 311. The first feeding member 41 includes a plurality of first outlets 411 which are displaced from each other in a transverse direction (D4) transverse to the longitudinal direction (D1) and which are disposed over and in register with the longitudinal grooves 33, respectively such that the pressurized molten resin 11 is delivered through the first outlets 411 into the longitudinal grooves 33, respectively when the conveyer belt 3 is moved into the starting end region 311.

The pair of the rails 1 extend in the longitudinal direction (D1) and are disposed outboard of the conveyer belt 3.

The mounting frame 8 extends in the transverse direction (D4) to terminate at two guided end regions 81 which are guided by the pair of the rails 1, respectively to permit the mounting frame 8 to transform between a synchronizing state where the mounting frame 8 is moved with the conveyor belt 3 and a non-synchronizing state where the mounting frame 8 is not moved with the conveyor belt 3. The mounting frame 8 includes an elongated frame body 82 and a key 84. The elongated frame body 82 is disposed between the guided end regions 81 and has a guiding slot 83 extending to terminate at a front end 831 and a rear end 832. The key 84 is guided to move along the guiding slot 83 and has a key end 841.

The second feeding member 42 is elongated along a lengthwise line. The key end 841 of the key 84 is configured to permit the second feeding member 42 to be mounted thereon so as to permit the second feeding member 42 to move between the front end 831 and the rear end 832 of the guiding slot 83.

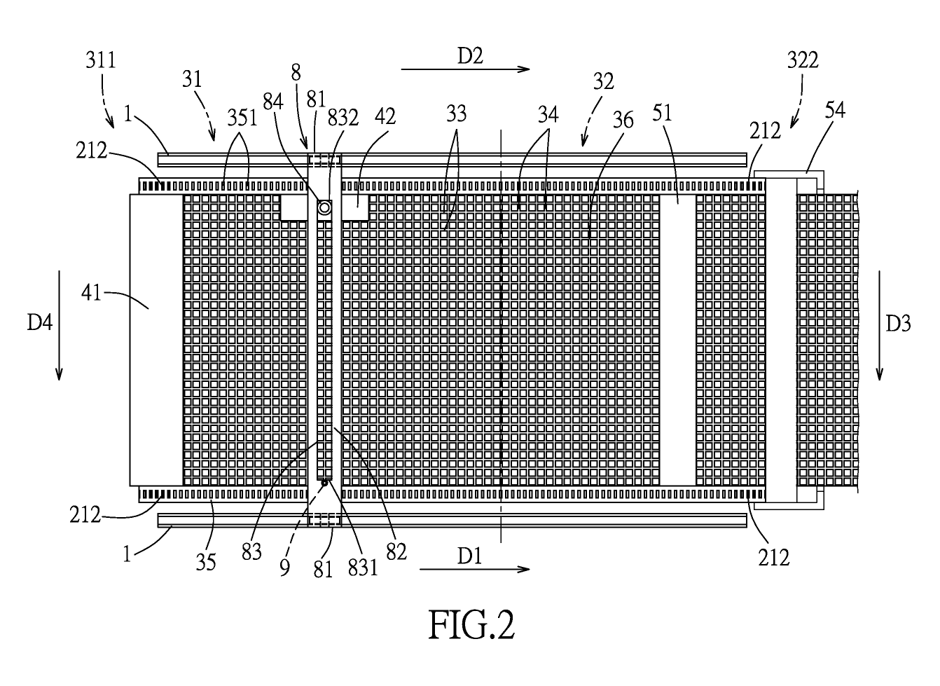

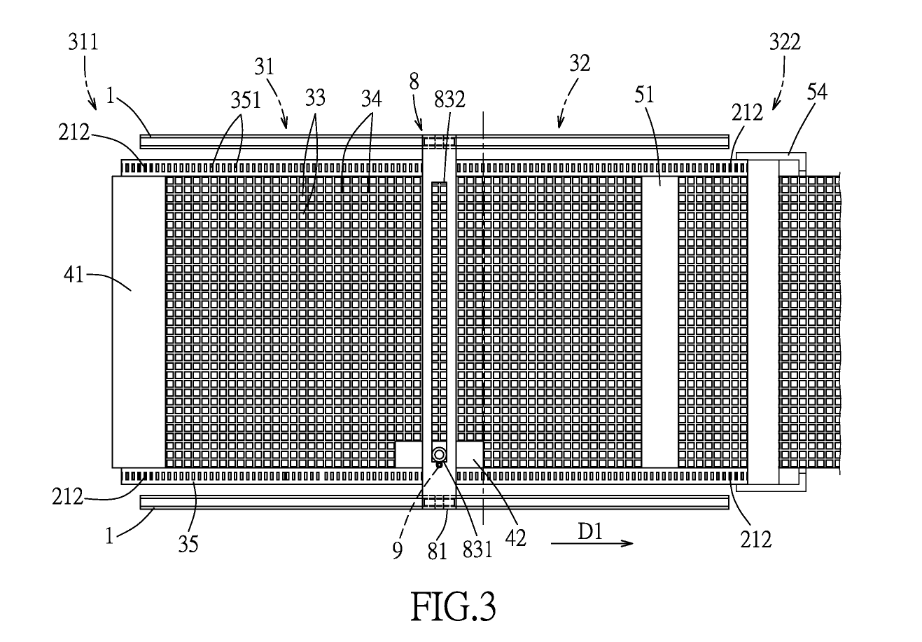

The second feeding member 42 includes a plurality of, second outlets (not shown) which are displaced from each other along the lengthwise line and which are mounted on the mounting frame 8 with the lengthwise line oriented in the longitudinal direction (D1) to permit the second outlets to be in register with the transverse grooves 34, respectively such that the pressurized molten resin 11 is delivered through the second outlets into the transverse grooves 34, respectively when the second feeding member 42 is moved in the synchronizing state, thereby forming a web of the pressurized molten resin 11 in the patterned mold 36 to be moved forward into the cooling zone 32 for making a continuous molded web 12. Specifically, in the synchronizing state, the second feeding member 42 is moved from the rear end 832 of the guiding slot 83 as shown in FIG. 2 to the front end 831 of the gliding slot 83 as shown in FIG. 3.

The sensor 9 is disposed on the mounting frame 8 to send out a signal in response to an ending of each run of delivery of the second feeding member 42. When the ending of a run of delivery of the second feeding member 42 is detected by the sensor 9, said mounting frame 8 is transformed from the synchronizing state to the non-synchronizing state and the second feeding member 42 is simultaneously moved from the state shown in FIG. 3 back to the state shown in FIG. 2 for a next run of delivery of the second feeding member 42.

The controller directs, in response to receipt of said signal, the mounting frame 8 to transform to the non-synchronizing state.

The cooling member 51 is disposed at the cooling zone 32 to accelerate solidification of the web of the pressurized molten resin 11. The cooling member 51 may be a water-cooling device, an air-cooling device, or the like. It should be noted that the cooling member 51 may be omitted, if desired.

The dyeing tank 54 is disposed downstream of the cooling member 51 for passing through of the molded web 12 to be dyed. Specifically, the molded web 12 is trained around a dyeing roller 541 to render the molded web 12 to pass through the dyeing tank 54 so as to dye the molded web 12. It should be noted that the dyeing tank 54 and the dyeing roller 541 may be omitted, if desired.

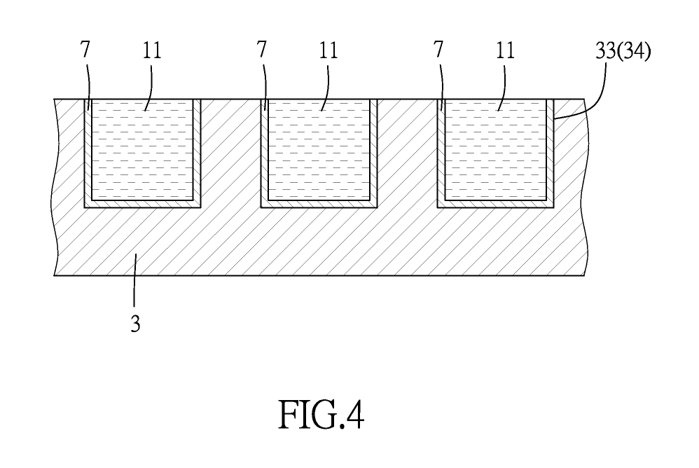

Specifically referring to FIG. 4, a releasing agent 7 may be applied on surfaces of the longitudinal and transverse grooves 33, 34 before the pressurized molten resin is delivered into the longitudinal and transverse grooves 33, 34 such that the continuous molded web 12 made by the apparatus according to the disclosure can be easily released from the conveyer belt 3.

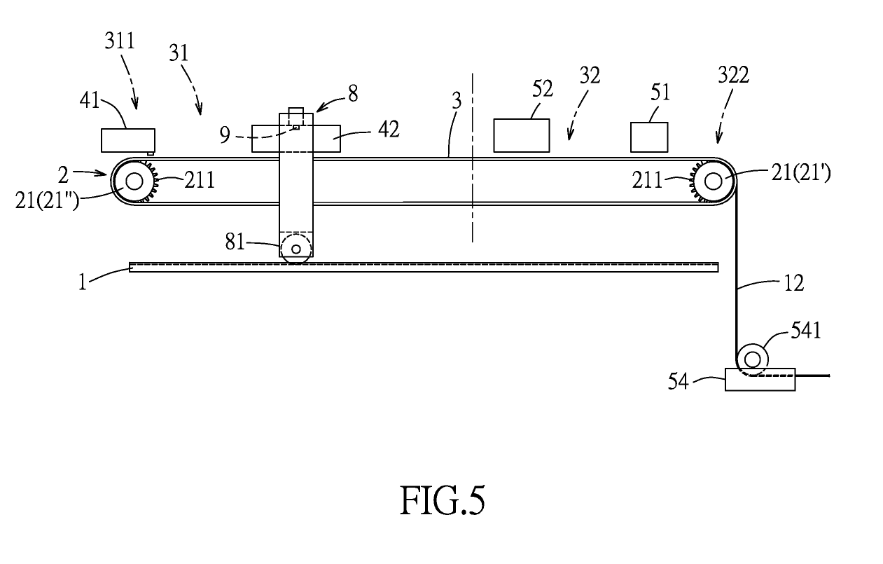

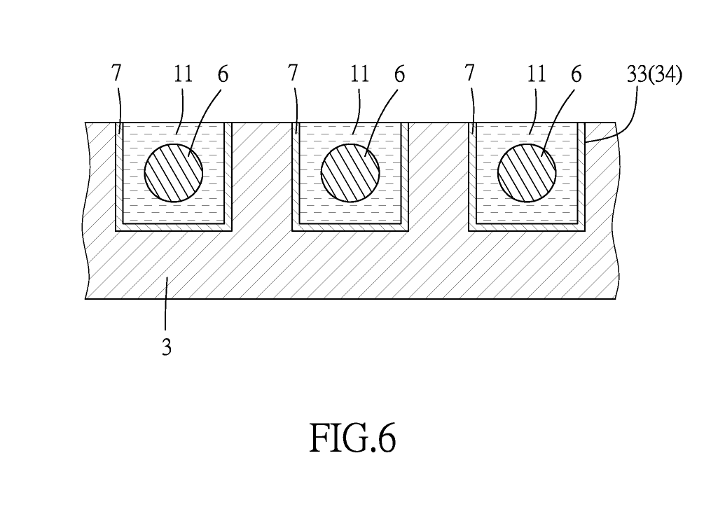

Referring to FIGS. 5 and 6, a second embodiment of an apparatus for making a continuous molded web according to the disclosure is similar to the first embodiment except that in the second embodiment, a heating member 52 is further included and disposed upstream of the cooling member 51 to maintain flowability of the pressurized molten resin in the patterned mold 36. Examples of the heating member 52 suitable for the apparatus according to the disclosure include, but are not limited to, a baking oven, a resistance heater, an infrared heater, a supersonic heater, and a heating roller. The second embodiment is especially suitable for making a continuous molded web with reinforcing metal wires 6 contained therein. As described above, the heating member 52 is used for maintaining flowability of the pressurized molten resin in the patterned mold 36 so as to permit the pressurized molten resin to completely cover the reinforcing metal wires 6.

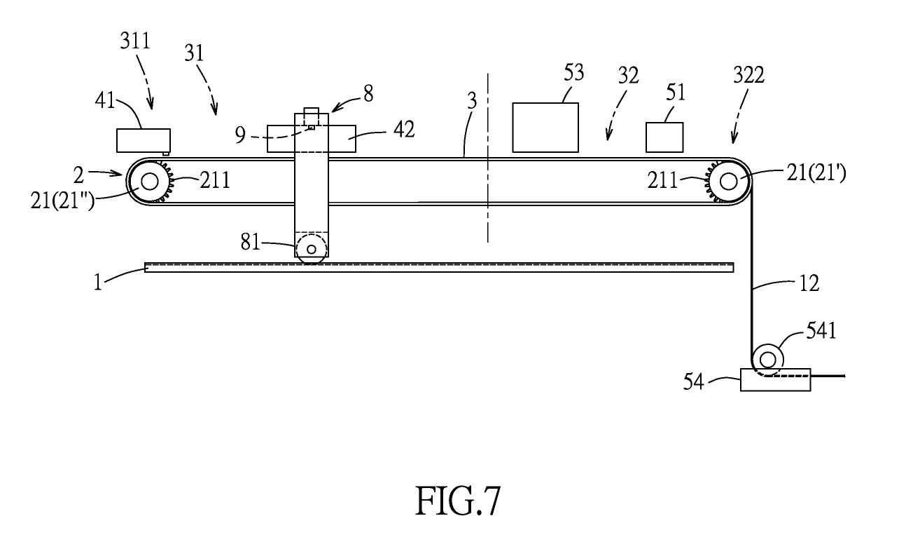

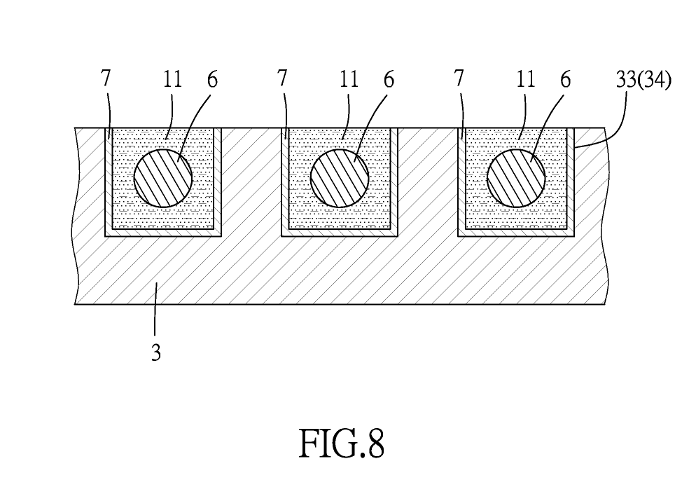

Referring to FIGS. 7 and 8, a third embodiment of an apparatus for making a continuous molded web according to the disclosure is similar to the first embodiment except that in the third embodiment, a recycling member 53 is further included and disposed upstream of the cooling member 51 to recycle volatile solvent which is added in the pressurized molten resin 11 to lower a melting point of the pressurized molten resin 11 before the pressurized molten resin 11 is delivered into the longitudinal and transverse grooves 33, 34. The third embodiment is especially suitable for making a continuous molded web with reinforcing metal wires 6 contained therein. The melting point of the pressurized molten resin 11 is lowered by adding the volatile solvent therein so as to permit the pressurized molten resin to completely cover the reinforcing metal wires 6.

In view of the aforesaid, a continuous molded web can be made efficiently by the apparatus of the disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An apparatus for making a continuous molded web, comprising:
a filling zone extending in a longitudinal direction to terminate at a starting end region and a first juncture region;
a cooling zone extending in the longitudinal direction to terminate at a second juncture region connected to said first juncture region and a finishing end region;
a plurality of rollers displaced from each other in the longitudinal direction;
a conveyer belt trained over said rollers to move along the longitudinal direction from said filling zone to said cooling zone, and including,
a plurality of longitudinal grooves which extend in a leading-and-trailing direction parallel to the longitudinal direction and which displace from each other in a widthwise direction, and
a plurality of transverse grooves which extend in the widthwise direction and which displace from each other in the leading-and-trailing direction to intersect said longitudinal grooves to form a patterned mold;
a first feeding member for delivering a pressurized molten resin in said starting end region, including a plurality of first outlets which are displaced from each other in a transverse direction transverse to the longitudinal direction and which are disposed over and in register with said longitudinal grooves, respectively such that the pressurized molten resin is delivered through said first outlets into said longitudinal grooves, respectively when said conveyer belt is moved into said starting end region;
a pair of rails extending in the longitudinal direction and disposed outboard of said conveyer belt;
a mounting frame extending in the transverse direction to terminate at two guided end regions which are guided by the pair of said rails, respectively to permit said mounting frame to transform between a synchronizing state where said mounting frame is moved with said conveyor belt and a non-synchronizing state where said mounting frame is not moved with said conveyor belt; and
a second feeding member elongated along a lengthwise line, and including a plurality of second outlets which are displaced from each other along the lengthwise line and which are mounted on said mounting frame with the lengthwise line oriented in the longitudinal direction to permit said second outlets to be in register with said transverse grooves, respectively such that the pressurized molten resin is delivered through said second outlets into said transverse grooves, respectively when said second feeding member is moved in the synchronizing state, thereby forming a web of the pressurized molten resin in said patterned mold to be moved forward into said cooling zone for making the continuous molded web.

2. The apparatus according to claim 1, wherein said mounting frame includes an elongated frame body which is disposed between said guided end regions and which has a guiding slot extending to terminate at a front end and a rear end, and a key which is guided to move along said guiding slot and which has a key end configured to permit said second feeding member to be mounted thereon so as to permit said second feeding member to move between said front end and said rear end of said guiding slot.

3. The apparatus according to claim 1, wherein said plurality of said rollers includes a leading roller and a trailing roller disposed at said finishing end region and said starting end region, respectively to permit said conveyer belt to be trained therearound so as to render said conveyer belt to be a looped one.

4. The apparatus according to claim 3, wherein each of said leading and trailing rollers includes two annular toothed end regions opposite to each other in an axial direction and each having a plurality of teeth, said conveyer further including two perforated marginal regions at opposite sides of said patterned mold, each of said perforated marginal regions including a plurality of perforations which are displaced from each other in the leading-and-trailing direction and which are configured such that when said conveyer belt is trained around said leading and trailing rollers, said perforations are sequentially brought into mesh engagement with said teeth of said leading and trailing rollers, thereby ensuring positive friction engagement therebetween.

5. The apparatus according to claim 1, further comprising:
a sensor disposed on said mounting frame to send out a signal in response to an ending of each run of delivery of said second feeding member; and
a controller which in response to receipt of said signal, directs said mounting frame to transform to the non-synchronizing state.

6. The apparatus according to claim 1, further comprising a cooling member disposed at said cooling zone to accelerate solidification of the web of the pressurized molten resin.

7. The apparatus according to claim 6, further comprising a heating member disposed upstream of said cooling member to maintain flowability of the pressurized molten resin in said patterned mold.

8. The apparatus according to claim 6, further comprising a dyeing tank disposed downstream of said cooling member for passing through of the molded web to be dyed.
